(19) United States
(12) Patent Application Publication
(10) Pub. No.: US 2012/0166249 A1
(43) Pub. Date: Jun. 28, 2012

(54) ASSET MANAGEMENT SYSTEM

(75) Inventor: Nigel P. Jackson, Malmesbury (GB)

(73) Assignee: OPTIMIZED SYSTEMS AND SOLUTIONS LIMITED, Derby (GB)

(21) Appl. No.: 13/395,994

(22) PCT Filed: Sep. 15, 2010
(86) PCT No.: PCT/EP10/63521

§ 371 Date: Mar. 14, 2012

(30) Foreign Application Priority Data
Oct. 7, 2009 (GB) 0917527.4

(51) Int. Cl. G06Q 10/06

(52) U.S. Cl. 705/7.28

(57) ABSTRACT

An asset management system includes a plurality of assets, a plurality of sensors for determining one or more operating conditions for each of said assets and one or more processors for determining a risk profile for each of the assets over time. The processor is arranged to calculate a risk index value for each asset from the risk profile, the risk index providing a relative indicator of the need for maintenance of an asset. A maintenance queue is established and assets are entered into the queue once the risk index value for that asset matches or exceeds a predetermined threshold value, the position of the asset in the queue being determined based upon the value of its risk index.

The present invention relates to an asset management system and more particularly, although not exclusively, to a system for management of engine use and maintenance for a fleet of vehicles.

Aircraft fleet planning is crucial to the operational success aircraft operators, both in terms of safety and efficiency. Fleet planning techniques also have significant impact on the commercial success of airlines, which are the focus of the following description. However such techniques may also be applied to fleets of military aircraft or other important assets, such as other types of engine or machinery, which may require periodic maintenance or replacement.

Examples of other scenarios in which the present invention may be applicable include machinery for other vehicles such as trains or ships, or machinery for processing plants, pumping stations, wind farms or other power generation equipment. All such examples have in common that an operator will typically control concurrent operation of a plurality of identical or similar assets, each of which represent high value assets to the operator and each of which require maintenance work in order to achieve an intended operational lifecycle.

According to conventional fleet management techniques, maintenance events for aircraft gas turbine engines are scheduled in order to meet regulatory authority requirements. It is also generally known to strive to arrange maintenance events around intended maintenance-free periods (i.e. periods in which maximum asset availability is required) within the repair capacity of an airline.

To this end, a number of commercially available maintenance planning software applications provide some form of scheduling capability. However in such conventional approaches, a significant level of human experience and input is required to ensure a suitable fleet schedule is proposed. The most important criteria to such a skilled person tend to be compliance with regulations and the avoidance of exceeding a given repair capacity. Thus a conventional approach to scheduling would be to first schedule for compliance and subsequently balance the schedule to manage the workload. If it is determined that capacity is overstretched or insufficient, then it may be that the repair capacity is increased accordingly.

However a system, for which the repair capacity is stretched during time periods of peak demands, represents inefficiencies over other time periods. A number of other factors, such as operating margin deterioration, reliability risks, availability of spares, etc, all influence a fleet. Accordingly conventional methods can lead to widely varying maintenance schedules being proposed by different people for a given scenario, each of which is based on the bespoke style of decision making of the individual, and none of which are likely to be optimal.

When a maintenance plan is enacted, it is highly likely in reality that some deviation from the plan will be required due to unforeseen circumstances, such as, for example, early engine removal for high priority repair or maintenance work. In such circumstances, the operator would typically attempt to triage the event and return to the existing plan as soon as possible thereafter. However the implications of such a strategy are generally unknown and the inventor has determined that such a reaction often results in a less-than-optimal plan.

Maintenance work for an engine may or may not require removal of the engine from an aircraft. The former situation represents a significant potential for disruption of a fleet of aircraft. To counter this disruption, aircraft operators may carry a number of spare engines to avoid aircraft being grounded for the duration of required engine maintenance work. Alternatively an aircraft operator may lease an engine for a period of time to replace the engine undergoing maintenance work. More commonly, an operator will use a combination of these approaches to accommodate the varying scenarios which could occur. In view of such potential approaches, it is a significant concern of aircraft operators that their maintenance plan may not be optimized.

Furthermore such conventional planning strategies are prone to manual error and can lead to significant overhead costs as well as the need for large contingency budgets to accommodate any flaws in the plan.

It is an aim of the present invention to provide a planning system and associated tool and method which allow for more efficient asset management.

According to one aspect of the present invention there is provided an asset management system for a plurality of assets, comprising a plurality of sensors for determining one or more operating conditions for each of said assets; one or more processors for determining a risk profile for each of the assets over time and calculating there-from a risk index value for each asset, the risk index providing a relative indicator of the need for maintenance of an asset; and, establishing a queue and entering each asset into the queue once the risk index for that asset matches or exceeds a predetermined threshold value, the position of the asset in the queue being determined based upon the value of its risk index.

The risk index may be captured as a number or other alphanumeric string.

The queue may comprise or take the form of a priority-ordered list or else a schedule. A schedule may include ordered and/or dated maintenance events for said assets.

Preferable features of the system are defined in claims 2 to 15.

According to a second aspect there is provided an asset management method according to claim 16.

Preferable features of the method are disclosed in claims 17 to 20.

According to a third aspect of the present invention there is provided an asset management tool according to claim 21.

According to a fourth aspect of the present invention there is provided a data carrier comprising machine readable instructions for operation of one or more processors to perform the method of the second aspect.

According to a fifth aspect there is provided a method and/or system of asset management according to claim 23.

Preferable features of the fifth aspect are defined in claims 24 to 29.

According to further aspects of the invention there is provided a tool and/or a data carrier comprising machine readable instructions for performing the method of the fifth aspect.

The one or more operational variable may comprises a measure of the operational age of an asset or a component thereof at the start of the time period. The one or more operational variable may additionally or alternatively comprise engineering design data for the asset or a component thereof.

Any, or any combination, of the preferable or essential features defined in relation to any one aspect of the invention may be applied to any other aspect of the invention wherever practicable. In particular, the aspect of the invention defined in claims 16 and 23 may be combined such that the determination of stagger for an aircraft or fleet may be performed based upon the risk index.

An asset may comprise a machine, such as for example an engine, turbine, power generation equipment, pumping equipment, chemical processing equipment, manufacturing equipment a vehicle or vessel or propulsion equipment there-for.

One or more working embodiments of the present invention are described in further detail below by way of example with reference to the accompanying drawings, of which:

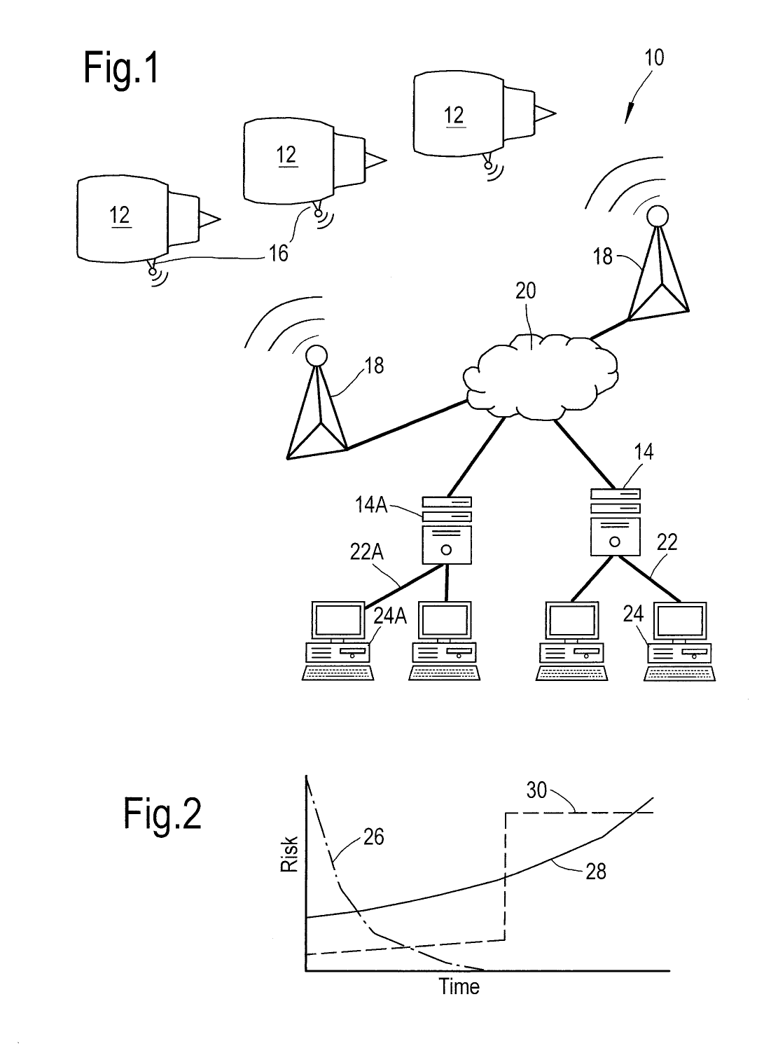

FIG. 1 shows a schematic of system in which the present invention may be implemented;

FIG. 2 shows a graph representing various asset risks which may vary over time;

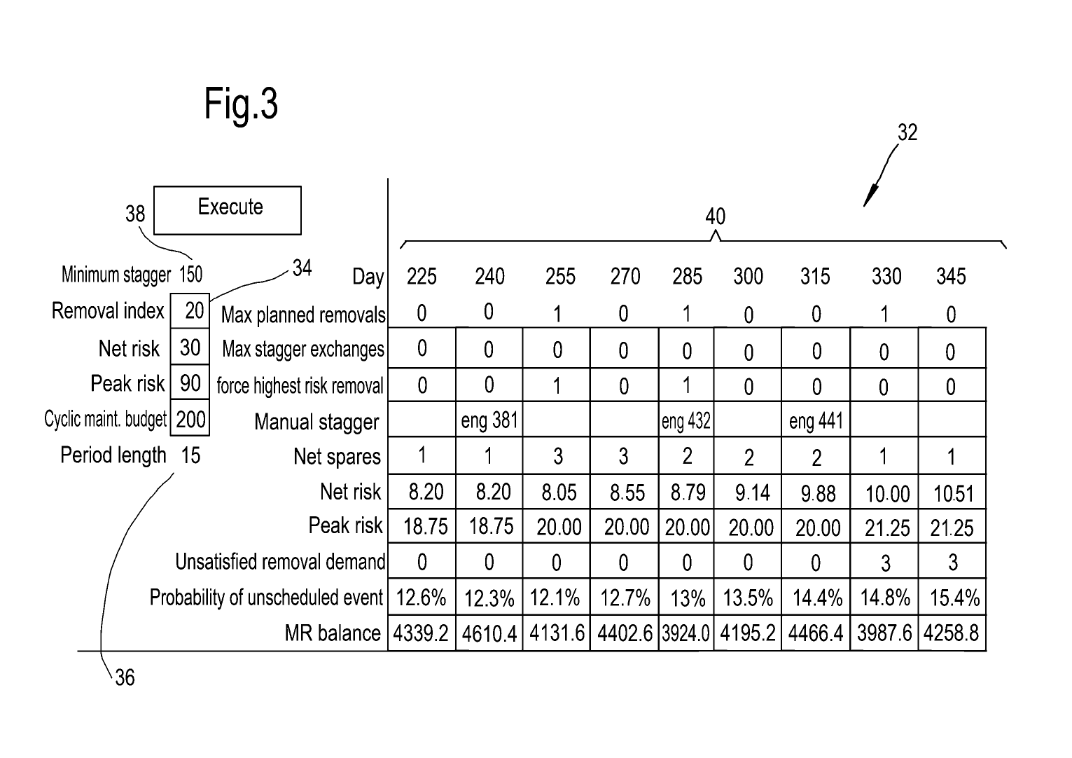

FIG. 3 shows a user control interface according to one embodiment of the invention;

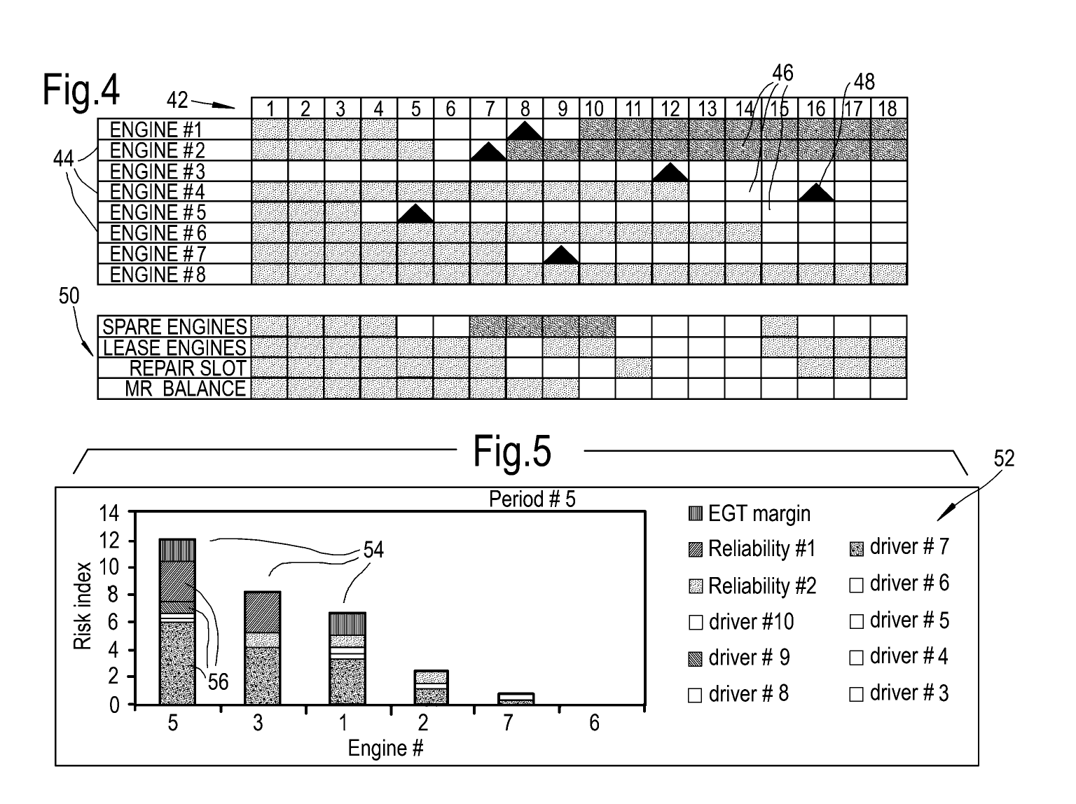

FIG. 4 shows a visual representation of risks for a plurality of assets over time;

FIG. 5 shows a visual representation of the determination of a cumulative risk for a plurality of assets;

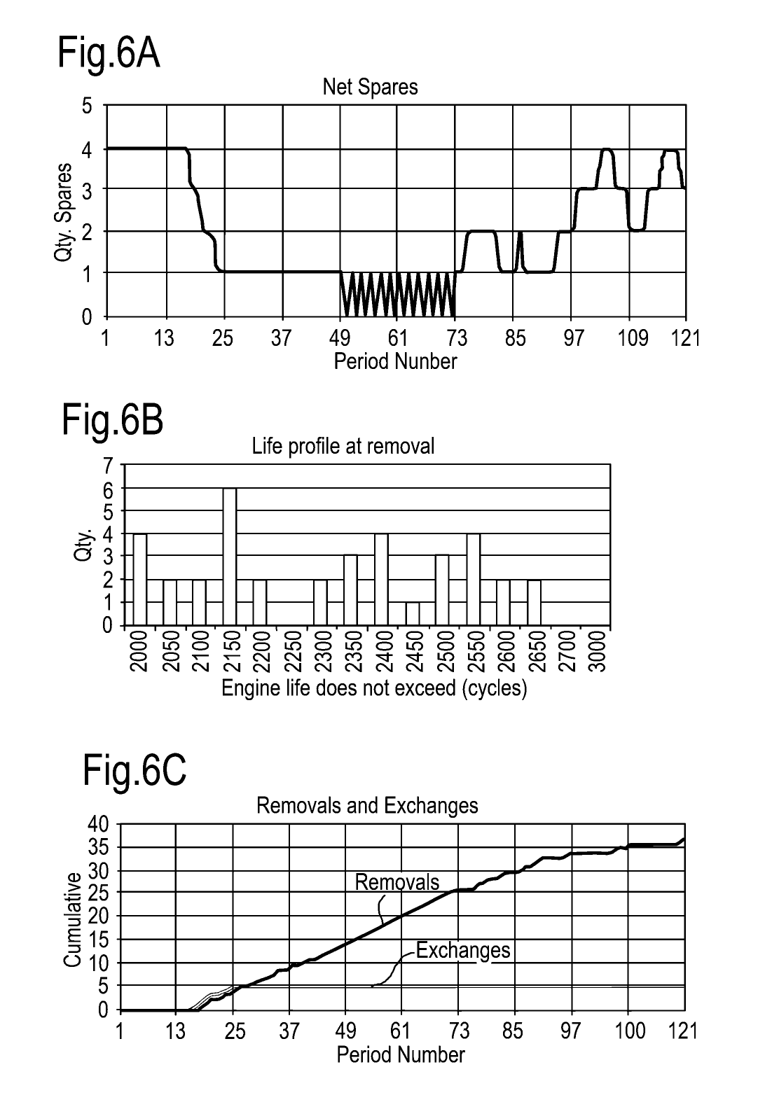

FIGS. 6A to 6C show various reports output by a tool according to one embodiment of the invention;

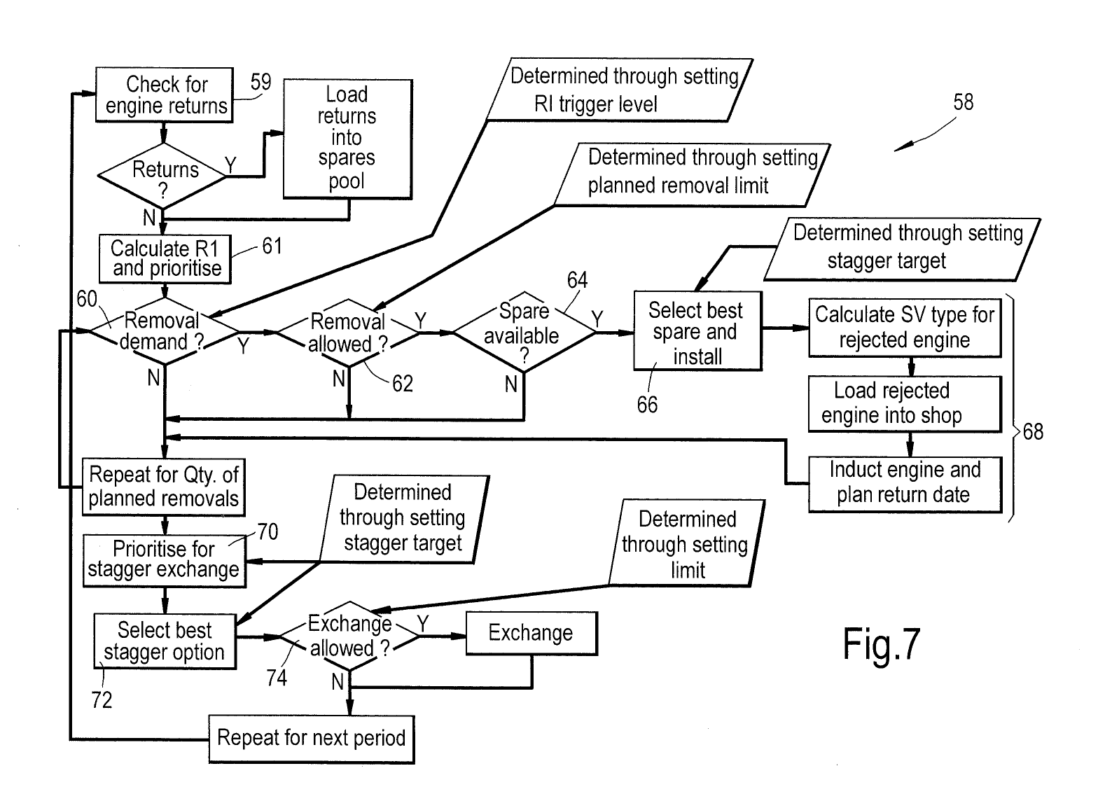

FIG. 7 shows a flowchart for determining maintenance events according to one embodiment of the present invention;

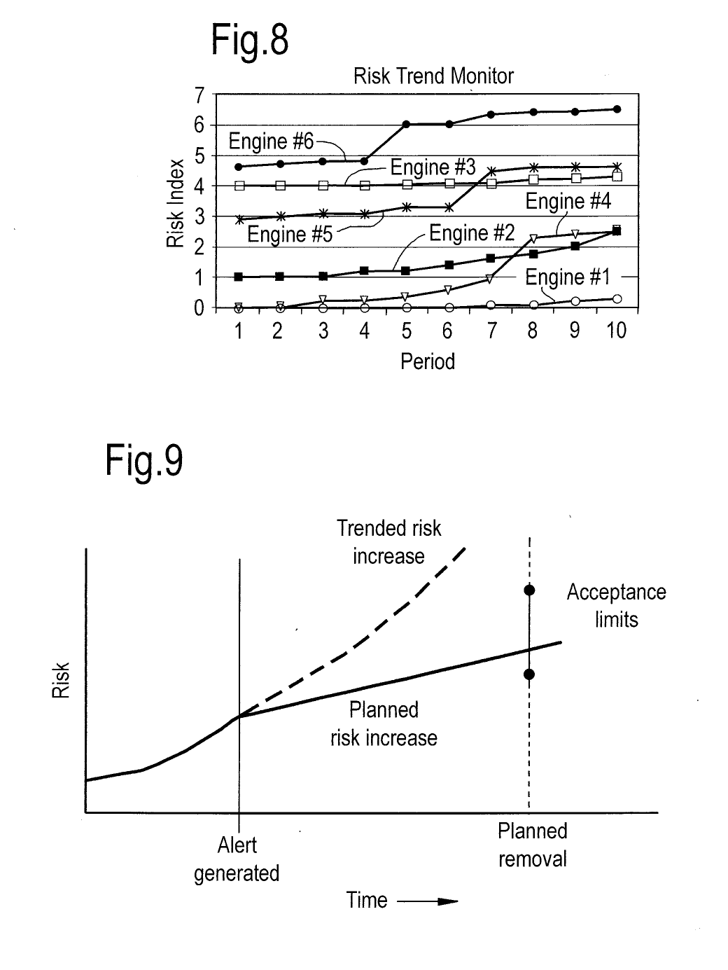

FIG. 8 shows an example of a graphical output of risk monitoring over time; and,

FIG. 9 shows a schematic graph indicating an example of risk reduction according to the present invention.

The embodiments of the invention described below allow for semi or fully automated scheduling of maintenance events for a number of assets in a manner which balances reliability, compliance and cost effectiveness with repair resources and infrastructure support capacity. This strategy allows optimisation of the availability of the maintenance or repair resources.

The scheduling process proposed below is underpinned by a formal risk modelling strategy which provides for a significant level of automation based on asset operator requirements. The provision of risk planning in this manner provides for a fleet of aircraft engines or other assets which are risk mitigated.

The aggregation of a plurality of perceived risks for an asset into a single tradable value, referred to as a risk index, allows maintenance needs for different assets to be compared and prioritised in a simple and effective manner.

The embodiments of the invention described below are applied to engines for a fleet of aircraft but may equally be applied to other high value assets which are owned by—or else at the disposal of—an asset operator and which require maintenance work to achieve a proposed service life. The invention is particularly suited to assets having a significant number of different failure modes.

The terms ‘maintenance’ and ‘maintenance events’ are used hereinafter to refer to any kind of actions which may be required to ensure correct functioning of an asset and which may include any or any combination of asset inspection, checking, testing, servicing, repair, overhaul, recall, adjustment, renovation, cleaning or the like. Whilst not described in detail below, the rationale of the present invention may be extended to include the decommissioning or other permanent removal of assets from service.

Turning now to FIG. 1, there is shown an overview of a system 10 in which the present invention may be incorporated. A plurality of gas turbine engines 12 are depicted which are in service or ‘on wing’ for a fleet of aircraft (not shown). Each aircraft in the fleet will typically have two or four engines 12 thereon.

Data relating to the operation of each engine 12 is typically collected over the engine operational life using conventional sensors and comprises a measure of the duration of operation of the engine, such as, for example, by way of a record of the operational age, the number of operational hours or flight cycles completed. The data collected will typically also include a variety of other operational measures such as fuel consumption, operation speeds or more detailed reports of performance as are common under conventional equipment health monitoring (EHM) practices. Conventional sensors known to those skilled in the art are located on an engine or aircraft to generate readings of any or any combination of Weight on Wheels (WoW), fuel consumption, operating time, cycle time or frequency, operational speeds (such as rotor speeds), temperatures, pressures and the like. It will be appreciated that the term ‘sensor’ as used herein covers apparatus such as clocks, timers and counting equipment, such as may be used to count accrued engine or flight cycles.

The operational data for the engines 12 is communicated to a control or monitoring centre where records for all engines in the fleet are gathered. This is achieved by transmission of operational data, typically at the end of each aircraft flight, from the engine or associated aircraft to a control centre server 14. In the embodiment shown one or more wireless transmitters 16 associated with each engine transmit data signals to a receiver 18, which may comprise a base station, for example within a cellular network. The data is transmitted from the receiver 18 to the server 14 via a wide area network (WAN) such as the internet 20.

It will be appreciated that a variety of methods for transmission of operational data may be used which may include different wireless data transmission standards or protocols or else a wired connection between an engine, or aircraft, and the internet 20. Alternatively operational data may be recorded to a removable data storage device such as a memory stick, laptop or even paper records or documentation for subsequent retrieval by and/or transmission to the server 14.

The server 14 is associated with a network 22, typically a secure local area or wide area network, over which the operational data can be disseminated for processing and or analysis using networked work stations 24.

The combination of server 14 and network 22 is generally described herein as a monitoring or control centre and may comprise an asset monitoring service provider or else the asset operator organisation. Depending on the particular setup for asset monitoring and control, the operational data may be communicated to both a service provider and also the asset operator. This is depicted by another server 14A and secure network 22A. Operational data may be transmitted to both servers 14 and 14A or else to the service provider only. The service provider may then process the data and make available a subset of data or else the results of the data processing to the asset operator, either by transmission thereof or else by hosting a web site which is accessible to the asset operator via the internet 20 or other network.

In any of the above described embodiments, the operational data is processed so as to allow planning and scheduling of required maintenance events in a manner to be described below. It is also possible that such processing could be carried out on-board an aircraft or else by processing means mounted on an engine 12 and subsequently communicated to the relevant monitoring or control centre. In the proposed implementation of the invention, the maintenance planning tool or application is server-based in order to provide for quality control and continuity.

The automated fleet maintenance planning tool derives at least in part from the basic concept of characterising each of the causes for maintenance into a single tradable attribute—a risk index—using a causal model. After combining the causal models for a single asset into an asset model, the relative value of the risk index is used to generate a prioritised list of assets—the highest risk index belonging to the asset with the highest need for maintenance. As assets age in service operation, the removal index will increase in proportion to the age of the causal models, the reduction in its operating margin or certified life, or increase in damage observed through inspections.

Turning now to FIG. 2, there is shown an example of different types of risks which may apply to a gas turbine engine (GTE) and how they are considered to vary over time. Any perceived risks, threats or limits which are applicable to the operation of GTEs can be modelled in this manner.

In this example, line 26 represents the risk of an infantile failure for a GTE which may be related to a manufacture batch issue or maintenance. This risk is maximal at the start of the GTE operational life (or initial period after maintenance) and decays over time such that the risk is considered negligible beyond a predetermined duration of use thereafter. Line 28 represents an age related reliability risk which starts at an initial risk level and rises with increasing gradient over time. Line 30 represents an operational, commercial or regulatory limit such that the associated risk adopts a lower value prior to the limit and then undergoes a step change such that the risk adopts a higher value thereafter.

Actual identified risks can be attributed to a particular risk type and modelled accordingly by applying characteristic values such as, for example, base level risk, rate of increase or decay, limit values and/or magnitude of step changes.

Whilst each of the types of risk identified in FIG. 2 adopt a similar scale or magnitude of risk, a real life scenario may include risks of significantly different magnitudes dependent on the likelihood of the risk coming to fruition and/or the likely level of impact of such an occurrence on the operation of the GTE. Accordingly risks can be weighted within the model to ensure they accurately reflect a real scenario.

The x-axis in FIG. 2 is generally indicated as relating to ‘time’ and may in practice allow risks to be calendar-dependent or else dependent on duration of use. Such dependencies may be carried through the planning system described below.

Once the risk modelling according to this technique has been completed, a total risk for an asset can be determined from a combination of the individually modelled risks. This may be achieved in one embodiment by adding all the risk values to give a total risk plot for an engine. This can be displayed as a graph plot for total risk of the type shown in FIG. 2. However alternative report formats have been found to better communicate the relevant information as depicted in FIGS. 4 to 6 and which can be automatically generated by the maintenance planning tool for input risk model data.

The total risk value for an asset provides an extremely useful parameter, referred to herein as the risk index or else maintenance index. The risk index can thus be used as an indicator of the level of need for maintenance work on an engine. In the particular case that removal of the engine from an aircraft is required, the risk index may be considered to comprise a removal index. Accordingly a risk index accounts for all maintenance scenarios, including, but not limited to, maintenance work which requires removal of an engine.

The data required by the maintenance planning tool depends on the risk models used. In a basic embodiment, the tool will require at least the following data for each engine:
Current age; and,
Time since last reset.

A planned utilisation sets the incremental age of the asset per period. The risk index will increase over time for each asset. For a more involved planning strategy, the projected utilisation rate per asset would be input along with an indicator of the relationship between the utilisation rate and each of the risk models included in the configuration set-up. Adjusting the planned utilisation allows the fleet planner to experiment with different utilisation models to test the resultant maintenance schedule as will be described below.

Whilst such a simplistic model can itself provide benefits, the usefulness of the information produced by the tool can be increased by increasing the volume and/or quality of data input to the tool. Such additional data may comprise any or any combination of: life limits; reliability; modification compliance; observed conditions; fuel consumption; oil debris; and/or any other EHM data recorded for the engine.

A potentially unlimited number of risk models can be used in the determination of the risk index. In the present embodiment, models are constructed to represent: Exhaust Gas Temperature (EGT) margin; lease engine return conditions; reliability issues; hard lives; observed conditions (e.g. from boroscope inspection results); report drill down to causes of risk. For EGT margin expiry, the risk model can be either set up to predict the margin expiry date given a current margin, or to use a predicted margin expiry date from an EHM system.

The risk modelling functions according to such embodiments of the present invention are described as an Asset Risk register tool. However this tool represents a departure from conventional modelling used by existing Asset Risk Register tools, which are based on simplistic parameters for life prediction or the like. In contrast the embodiments of the present invention make use of rigorous engineering data and techniques, including fault tree models and the like, obtained form the relevant engineering discipline or team.

With the addition of capacity limits for spare/lease assets and planned maintenance activity, a risk profile for the fleet, a maintenance cost prediction and a demand for spare/lease assets can be determined.

The risk index is calculated in a number of forecast periods over a working horizon. The exit of one forecast period provides the entry or boundary conditions for the ensuing period and so forth for the entire working horizon to be forecast.

Turning now to FIG. 3, there is shown a user interface 32, via which a user can generate an optimized maintenance plan. In operating the maintenance planning tool, a user undergoes the basic process of:
1. defining scope and setting targets/limits
2. initializing tool
3. balancing the output plan prior to approval and distribution.

In the target setting stage, a fleet planner sets a risk index threshold value 34. This value is used by the tool to automatically determine when an engine is to be queued for maintenance. When a risk index for an engine exceeds the threshold it is queued for removal or maintenance in the order determined by the magnitude of the risk index value.

In addition the fleet planner sets a period length 36 over which the plan is to be determined; a maximum number of maintenance events for the period; and, a target or minimum stagger value 38 for maintenance events (particularly in the case of engine removals).

The generation of a schedule based upon one or more values of stagger represent a further aspect or embodiment of the invention which may or may not require use of the risk index.

When managing a plurality of assets, it is beneficial if the assets do not fall due for removal all at once. The time at which an asset falls due for removal may be due at least in part upon the operational age of the asset. A number of other attributes or risks (as discussed above) may contribute to the determination of when a maintenance event is due. Thus a stagger value can be defined which is indicative of the spacing between predicted or past maintenance events for two or more assets. If it is considered that a brand new fleet of aircraft may all have brand new engines which enter service on the same date, those engines could potentially all fall due for age-related maintenance on the same date. This therefore represents an unfavourable case of zero stagger for each aircraft.

In reality, the value of stagger based purely on engine age or operational age represents a simplistic embodiment and further parameters and/or risks may be defined as contributing to stagger, such as EGT margin, time to compliance date, etc. For some of these risks—such as operational age—it is beneficial to achieve a relatively large stagger (up to a predetermined threshold). That is to say, it would help to ensure spaced maintenance events for a plurality of engines on an aircraft, if the engine were not of identical age. However the age of the engines would ideally not be so different (beyond a predetermined threshold) that the operational considerations for those engines are vastly different. In a practical example, the threshold may be set at 1,000 flight hours or a similar value.

A numeric value is assigned as being representative of stagger. The value 38 set by the user in this example represents a minimum stagger which is acceptable in the determination of the schedule. Typically a user will also set a target stagger such that the tool can iterate towards an optimal stagger scenario in a manner to be described below in relation to FIG. 7.

The tool is then initialized in order to produce an initial plan, for which the reporting fields indicated at 40 in the interface 32 are populated. The maintenance planning tool automatically generates a schedule of removals/maintenance events and engine exchanges to meet the targets. The report generates a report on the success of this plan relative to the optimal targets using the parameters shown in reporting section 40 of the user interface 32. The variation in the parameters following parameters over time is output as a display for the user:
Maximum planned asset removals
Maximum stagger engine exchanges
Incidences in which a maintenance event for the highest risk index is forced
Net spare engines available for exchange
Net risk value
Peak risk value
Number of unsatisfied removal demands
Probability of an unscheduled event occurring

Through iterative adjustment of the policies and constraints, a plan that best matches the planning targets can be generated. These adjustments may be made by the user if a degree of manual control is desired or else may be automated by the maintenance planning tool based on pre-determined iterative schemes.

Value ranges for each of the parameters 40 may be prescribed in the tool to indicate acceptable, cautionary or unacceptable (high risk) conditions in the results. This is graphically represented to the user in a readily understandable manner by colour coding of time periods for each parameter in the display. A traffic light colour scheme is used for this purpose in this embodiment, although other colour schemes or visual indication methods may be used dependent on the requirements of the airline. The tool is configurable by an asset operator or service provider in this regard.

The iteration solution involves adjusting planning constraints to balance risk, spare engine availability, maintenance resource and compliance. Such constraints comprise the initial user inputs 34-38 described above. In addition the user has the ability to adjust engine utilisation and/or move planned maintenance events in order to achieve the desired balanced output. The basic aim of the iterative approach is to achieve a generally smooth maintenance event rate, which avoids peaks and troughs in maintenance demand whilst meeting essential maintenance requirements.

FIG. 4 shows a visual report 42 of asset risk for a plurality of engines over a working horizon in a grid timeline format having a two-dimensional array of cells. This may be referred to as a ‘Fly-Forward Report’. Each row 44 is assigned to an asset, in this case a particular engine within a fleet, and the columns represent a series of sequential time periods for a working horizon.

Each cell 46 in the grid depicts a time period for an engine and is assigned a visual indicator in the form of a colour coding by the tool indicative of the level of risk or risk intensity associated with that time period. The colour coding typically matches that described above in relation to the user interface of FIG. 3. Planned maintenance events are shown in the grid by markers 48.

Appended to the engine grid 42 is a corresponding grid 50 in respect of resources available to the airline, which comprise available spare engines, leased engines, repair slots and an indicator of balance between maintenance event which do and do not require engine removal. Similar colour coding of the acceptable or unacceptable nature of the values for each time period of grid 50 is provided as for grid 42.

The combined grids 42 and 50 provide an alternative visual indication of the proposed strategy which can help a user appreciate the efficacy of the proposed plan. Planned maintenance events are shown as milestones and the risks of non-availability of spare engines, lease engines and/or workshop slots for proposed maintenance events are easily discernable. Other risks can be added to the plan analysis as required.

Turning now to FIG. 5, there is shown a further graphical output 52 of the planning tool, which depicts the aggregation of the risk per asset over the prescribed time period.

The graphical output 52 is in the form of a histogram or bar chart in which the height of each bar 54 depicts the magnitude of the aggregated risk for an asset. Each bar is divided into different sections 56, each section indicating the contribution of a particular risk to the aggregated risk per asset per period. A user visualisation function allows toggling between views of the residual risk breakdown when planned maintenance events are either included or excluded. Thus a user can appreciate contributions of risk and the impact of maintenance events on the aggregated risk to determine whether alternative solutions are more or less effective at reducing the risks or components thereof.

It is important to note that certain events may impact on some risks but not others, which can be visualized in the chart 52 of FIG. 5.

Further examples of reports in the form of graphics, charts or the like, which are output by the tool, are shown in FIGS. 6A to 6C. FIG. 6A shows a plot of the available number of spare engines over the relevant time period according to a proposed plan. FIG. 6B shows a life profile for the engines at removal. In this chart the number of engines removed at a given engine life (determined by number of flight cycles) is shown in a histogram format. In FIG. 6C the cumulative number of engine removals is plotted alongside the cumulative number of engine exchanges over the relevant time period.

Such examples represent only a handful of examples of a large number of reports which can be generated by the tool according to user preferences. For a given schedule of maintenance events over time the tool may produce outputs for:
Fleet net risk profile
Fleet maintenance cost profile
Fleet maintenance reserve balance
Fleet residual asset value profile.

Turning now to FIG. 7, there is shown a flowchart 58 representing a process which may be followed by the tool according to one embodiment of the invention when determining a maintenance plan based on the user inputs. The process may be implemented by one or more modules of machine readable code in the form of a software application running on computational hardware, such as a server 14, workstation 24 or other suitable processing means.

For a given time period, the tool initially checks for engine returns into the spares pool at 59 and loads them into the pool of engine spares if necessary.

At 61, the tool calculates the risk index for each engine which has associated therewith a risk model as described above. The tool then selects the highest risk index found for that time period.

At 60, the tool compares the highest risk index for the plurality of engines against the previously-defined risk index threshold value 34. If the highest risk index value for an asset exceeds the risk index threshold, then a maintenance demand for that asset is determined and added to the total number of planned maintenance events. The engine is queued for removal or maintenance in the order determined by the magnitude of the risk index value.

Once maintenance demand is triggered, the demand is queued awaiting confirmation that resources are available and the capacity for the required maintenance is available. If it is, then the maintenance action can proceed—if not, it will remain queued until there are resources and capacity available.

For example, at 62 the tool determines whether the addition of the maintenance event for that asset would cause the total number of planned maintenance events to exceed the planned maintenance limit, which was set at the target setting stage. If not, the maintenance event is determined to be allowable.

Once the maintenance event is allowed, the tool determines at 64 whether the maintenance event requires removal of the engine and whether a spare engine is available in the spares pool to replace the engine to be removed. If so an appropriate spare is selected at 66 according to the preset stagger target.

If there is repair capacity, a spare available and permission to perform the maintenance being queued (through setting the planning constraints), the removal/maintenance will be simulated to occur. The tool then carries out a series of steps 68 to load the engine into a maintenance repair plan and determine the return date of the engine or else the date at which the engine will be available for use after the planned maintenance event.

If necessary, from the pool of available spares, the best matched replacement asset is selected and installed, whilst the removed asset is loaded into the repair queue. The nature of the repair work required is established according to workscope policy and this will take place when the asset can be inducted. The expected return date and condition is calculated depending upon the workscope and repair turn time.

If a maintenance event is deemed not to be possible within the constraints set by the user (either because there is no more capacity at 62 or there are no more available spare engines to meet a required removal at 64), the tool proceeds without scheduling that event. The resultant plan may still be deliverable, but it may not meet all the plan requirements. For example, by delaying maintenance action, it may cause the risk to be unacceptable, or a compliance date may be missed.

As an alternative definition of the invention, the asset management tool may be considered not only to predict the demand for maintenance based on risk modelling but also to then simulate how the demand will be satisfied according to the available resources. The tool can thus report on the success of the balanced plan—allowing the simulation/process to be re-iterated with new boundary conditions until a deliverable maintenance plan is achieved within resourcing limits and within acceptable plan quality limits.

The process of stages 60 to 68 is repeated for each engine in turn for that time period in order determined by the magnitude of their associated risk index values.

Once it is determined that no more removals for that time period are required, the tool then undergoes a series of steps to ensure the engine stagger of aircraft is optimised for the given constraints. In the manner described below, the need to remove and exchange engines for maintenance reasons is used to help achieve an improved engine stagger for individual aircraft or else the whole fleet. An engine exchange of this type is referred to as a ‘stagger exchange’. The number of allowable stagger exchanges for the working horizon or time period thereof is set by the user in the target/limit setting stage.

At 70 the maintenance plan is checked or modified to aim to achieve the preset stagger target for engine exchanges or else to ensure minimum and/or maximum stagger boundaries are adhered to. This is achieved by one or more routines which survey the engines in the fleet to determine a level of stagger for aircraft in the fleet. The aircraft are then prioritized in order of engine stagger, such that the aircraft having the least acceptable or least desirable engine stagger is given the highest stagger priority and the aircraft having the best stagger is given least priority. It is to be noted that the assessment of the best or worst stagger may differ for different types or risk. For example, for engine age it would be desirable that the engines on an aircraft are staggered in age as far as possible up to a maximum threshold. However for EGT margin, it would be desirable that engines on a single aircraft display similar EGT ratings. Stagger values are assigned to each modelled risk to generate a total stagger value for an engine.

The stagger assessment routine 70 goes on to determine whether exchanging one or more engines on an airframe with an engine in the spares pool would improve the stagger for that airframe. That is to say the stagger values for one engine configuration are compared to those for other available engine configurations. If an improved stagger is achieved for a stagger exchange then it is selected and the count of available stagger exchanges is reduced accordingly. If none of the available stagger exchange options sufficiently improve the stagger, then a stagger exchange for that airframe is not selected and the routine goes on to consider the next airframe in the order of stagger priority. The tool then determines at 74 that the proposed engine exchange(s), if required for planned maintenance work, is/are allowed according to a preset exchange limit. This results in acceptance or rejection of proposed exchange(s).

This is repeated either until all the available stagger exchanges have been assigned or else until all airframes have been assessed, whichever occurs first.

If alternative stagger options are determined as being available according to maintenance resources, the configuration which most closely matches the target stagger value is selected at 72. This serves to ensure maintenance events are evenly spread as far as possible, so as to avoid periods of excessive strain on maintenance resources.

In assessing the beneficial or detrimental impact of an engine configuration or a proposed stagger exchange, a numeric value is defined, which is referred to herein as the stagger index. The stagger index represents a count of the number of times the target stagger is met or exceeded on an airframe. The stagger index value is incremented by 1 for every engine pair combination for which the target stagger value is met or exceeded. The stagger between engines may be zero if all engines have the same operational age (i.e. all engines have completed the same number of operational cycles). For a twin engine aircraft, the stagger index value may thus be either 0 or 1. For an airframe having four or more engines, the stagger index value may be anywhere between 0 and 6 based on the stagger existing between each engine pair combination on the airframe. The total stagger value can be considered to be the aggregation of stagger index values for all engines in the fleet.

By setting a minimum stagger value for maintenance events, a user can ensure that the combined engines in the fleet have achieved a predetermined minimum amount of usage between maintenance events. The amount of usage is typically recorded or predicted in terms of usage/engine cycles although other parameters could be used such as operational hours or other specified periods of use. A user may also set a maximum stagger value to ensure maintenance events are staggered between predetermined boundaries. This serves to avoid unbalanced or inefficient use of maintenance resources.

The whole process is then repeated for the next time period within the working horizon for which maintenance is being planned. Accordingly, the time is incremented and the process restarted at step 59 for the new time period.

Whilst the stagger modelling and scheduling described above is determined in the above example based primarily on operational age of engines (as the key risk affecting the stagger values), other risks may be used. In an embodiment which is in some ways preferred, the stagger values may be determined base don the risk index values discussed above in relation to FIGS. 2 to 6 and the stages 60-68 of FIG. 7.

The completion of the process for all subsequent time periods results in the automated fleet maintenance plan being generated for the user as described in relation to FIGS. 4 to 6 such that a user can balance the output plan as necessary prior to sign off and communication to the relevant parties. This further optimisation is not essential to the invention but is considered a realistic stage in a practical solution such that a fleet planner has the option to further tailor or at least verify compliance of the automated plan. Actionable reports are generated, in this case listing engine removal schedule. Other reports could include current condition and future condition at end of lease, etc.

Through development of the plan, visibility is provided for all the important attributes of a plan such as the impact on availability, maintenance cost, need for lease assets, lease return conditions, repair loading, coincidence of asset and platform maintenance, etc. This visibility allows collaborative working in different contributing disciplines, and provides a common plan for an organisation. The consequences of planning decisions can be evaluated in commercial terms, for trading of plan with availability and risk. The speed of re-calculation to the planning constraints allows for rapid and repeatable decision support.

Achieving an acceptable balance is the key to fleet planning. This tool satisfies a need to balance availability, maintenance yield, maintenance reserve, operating cost and risk within a strict compliance framework. The outputs from the plan set operating budgets and provide compliance statements for stakeholders. These are key attributes of a marketing plan, and can influence the scope of this plan and the product portfolio used to deliver it.

Turning now to FIGS. 8 and 9, during the operation, actual utilisation may vary from that originally expected due to the occurrence of unexpected events, and it is—to some degree—inevitable that the plan will need to be modified over time to restore the acceptable balance.

Once the plan has been solved, further risk assessment and mitigation is attempted through forecasting the risk of unplanned events and how the plan can accommodate these uncertainties. This could lead to further development of the policies and constraints if a more robust plan with greater chance of success is needed—or it may allow outsourcing of contingency capacity.

To this end, the risk index for each engine is monitored and/or trended over the time periods for which the maintenance plan has been created. Unwanted or unexpected variations in asset risk profiles are used to draw attention to emerging threats. A threshold allowable deviation from a planned risk profile can be preset such that an alert is generated when an asset risk strays beyond the limits of that threshold. Such deviation thresholds may be set for rates of change of risk which are either greater than or less than predicted since either case is indicative of an inaccuracy within the plan.

Threshold allowable deviation limits are shown in FIG. 9 as acceptance limits which may be determined for individual assets and/or for an entire fleet based on the accumulation of the risks for all assets.

Such risk reporting is carried out over the entire timeframe of the working horizon for which the plan has been generated. Regular status updates, minor re-planning and alerting when the planning constraints need to be adjusted give the best opportunity for the balance to be maintained and any predicted issues mitigated. Monitoring reports and resulting updated plans are issued to stakeholders.

Embodiments of the present invention provide for significant progress towards automated optimisation of maintenance scheduling with minimal human intervention—allowing high value decision support and significant risk and cost reduction. The invention allows co-incidence of maintenance events to be avoided wherever it would be detrimental to operation of a fleet and significantly reduces the likelihood of an aircraft being grounded for engine maintenance due to spare engines being unavailable. Thus an airline can achieve most efficient use of a potentially smaller number of spare or leased engines.

The present invention may also allow for a split between global and local fleet planning. Global planning could account for any or any combination of: availability of lease engines; availability of shared spares; availability of repair slots; risk levels by policy. Local planning could account for: management of risk; management of stagger; management of repair; management of maintenance reserve. Accordingly the tool can allow use at different levels of hierarchy within an airline within a common framework such that plans and associated data can be passed there-between.

As a development to the above-described embodiments, it is also possible to use the asset management system or ‘stagger model’ in a forecasting mode. In such a use, sampling of failures (such as by way of, so-called, Monte Carlo methods) can be used to test the resultant plan for stability. Thus unplanned failures can be randomly introduced to test how the plan recovers. Several iterations are performed, and statistically it is possible to report on the confidence that a plan can deliver against the intended performance. This introduces another potential tradable attribute, by way of a stability value, such that both a risk index and a stability value can be used in determining a suitable plan. For example, a user can trade plan stability with risk—leading to account being taken for any contingency that needs to be available for a determined plan.

The present invention is also applicable to maintenance or exchange scheduling for gas turbine engines used in power generation applications.

1-31. (canceled)

32. An asset management system comprising a plurality of assets under the control of an asset operator;
a plurality of sensors for determining values for one or more operation variables for each of said assets;
a risk model for each asset comprising a plurality of risks derived from the determined values of operation variables; and,
processing equipment arranged to calculate a risk index value for each asset based on an aggregation of said risks over a predetermined current and forecast time period, the risk index value providing a relative indicator of the need for maintenance of an asset in said plurality of assets, and to establish a queue in which maintenance events are assigned to assets requiring maintenance based upon their associated risk index value.

33. An asset management system according to claim 32, wherein the processing equipment determines at least one of the severity of a need for maintenance of an asset and a priority level of the maintenance event for an asset based upon the magnitude of the associated risk index value.

34. An asset management system according to claim 32, wherein a maintenance need is determined when the risk index value for an asset matches or exceeds a predetermined risk index threshold value.

35. An asset management system according to claim 32, wherein the risk model comprises a plurality of different types of risk, the risk index value for each asset being determined based on an aggregation of the risk for each risk type.

36. An asset management system according to claim 32, wherein the risk model comprises risk profiles for each of said plurality of risks over said predetermined time period, said risk profiles being dependent on the determined values of operational variables and wherein the risk profiles are calculated as a function of the proposed usage of the asset over said time period.

37. An asset management system according to claim 32, wherein the risk index value comprises a maintenance index value.

38. An asset management system according to claim 32, wherein the processing equipment iteratively determines a schedule of maintenance events for a first time period and successive time periods thereafter, said first and successive time periods in combination defining the forecast maintenance period and wherein any or any combination of the risks, maintenance needs and/or maintenance events determined for said first time period are input as conditions for determination of a schedule for one or more successive time periods.

39. An asset management system according to claim 32, wherein the one or more operational variable comprises at least one of the group comprising a measure of the operational age of an asset or a component thereof, a prediction of the proposed use of an asset over the time period, and equipment health monitoring data.

40. An asset management system according to claim 32, wherein the assets comprise one of the group comprising engines for a fleet of aircraft, turbines, power generation equipment, pumping equipment, chemical processing equipment, manufacturing equipment for a vessel or vehicle, and propulsion equipment for a vessel or vehicle.

41. An asset management method for a plurality of assets comprising;
determining or importing a risk model for each asset, said risk model comprising a plurality of risk profiles corresponding to operational risks associated with an asset;
calculating a risk index value for each asset based on an aggregation of said risk profiles over a predetermined current and future time period, the risk index value providing a relative indicator of the need for maintenance of an asset in said plurality of assets,
establishing a schedule in which maintenance events are assigned to assets requiring maintenance according to an order of priority based upon the risk index value associated with each asset.

42. An asset management method according to claim 41, wherein the schedule is established by:
determining maintenance events to be satisfied for said time period;
queuing said maintenance events;
determining whether said maintenance events fall within available maintenance constraints;
satisfying said queued maintenance events according to an order of priority based upon the risk index value for the asset associated with each event.

43. An asset management method according to claim 42, wherein the maintenance constraints comprise any or any combination of: spare asset availability; a maximum number of allowed maintenance events per time period; and/or, a predetermined stagger target or threshold.

44. An asset management method according to claim 41, wherein a priority level of a maintenance event for an asset in the schedule is determined based upon the magnitude of the associated asset index value,

45. An asset management method according to claim 41, wherein a maintenance need is determined when the risk index value for an asset matches or exceeds a predetermined risk index threshold value.

46. An asset management method for a plurality of assets, said assets comprising a plurality of assets in service and one or more spare assets, said method comprising;
determining or importing an operational risk for each asset based at least in part on a duration of operation;
determining one or more maintenance needs for said assets for mitigating said operational risks;
calculating a stagger value for said assets in service based upon a difference between the maintenance needs of said assets;
calculating an alternative stagger value based upon a difference between the maintenance needs of a first of said assets in service and a first of said spare assets;
comparing said stagger value with said alternative stagger value to determine whether the difference there-between meets a target threshold of change in stagger; and,
automatically scheduling removal of said first asset from service for maintenance and replacement thereof with said first spare asset in the event that said target threshold is met.

47. An asset management method according to claim 46, wherein the calculating of an alternative stagger value comprises calculating a plurality of alternative stagger values in respect of alternative spare assets.

48. An asset management method according to claim 47, comprising:
comparing said stagger value with said plurality of alternative stagger values;
selecting an alternative stagger value which best matches said target stagger threshold; and,
automatically scheduling removal of said first asset for maintenance and replacement thereof with the spare asset which corresponds to said selected stagger value.

49. An asset management method according to claim 46, comprising iterating said calculating and comparing actions for each of second and subsequent assets in service.

50. An asset management method according to claim 49, wherein the assets in service are grouped based upon an operational relationship there-between and the stagger value for each group is compared against alternative stagger values for said group.

51. An asset management method according to claim 49, comprising prioritizing assets for replacement based upon the magnitude of the stagger value thereof.

52. An asset management method according to claim 48, comprising establishing a schedule in which maintenance events are assigned to assets having a predicted maintenance need occurring over a specified time period, said schedule specifying assets to be removed from service and replaced with spare assets.

53. An asset management tool comprising processing equipment under the control of machine readable instructions to perform the method of claim 41.

54. A data carrier comprising machine readable instructions for the control of one or more data processors to perform the method of claim 41.
